(19) United States
(12) Patent Application Publication
(10) Pub. No.: US 2015/0334986 A1
(43) Pub. Date: Nov. 26, 2015

(54) INDIVIDUALLY VENTILATED CAGING SYSTEM

(71) Applicant: Alternative Design Manufacturing & Supply, Inc., Siloam Springs, AR (US)

(72) Inventors: Grant A. Loyd, Siloam Springs, AR (US); Matt L. Beard, Cave Springs, AR (US); Timothy L. Benson, Fayetteville, AR (US); Cody Alan Ulaga, Siloam Springs, AR (US); Everett Dewayne Noblin, JR., Watts, OK (US)

(21) Appl. No.: 14/693,691

(22) Filed: Apr. 22, 2015

Related U.S. Application Data
(60) Provisional application No. 61/983,023, filed on Apr. 23, 2014.

(51) Int. Cl. A01K 1/03; A01K 1/00

(52) U.S. Cl. CPC A01K 1/031; A01K 1/0076; A01K 1/0052

(57) ABSTRACT

The present invention relates to a caging system for storing a number of cages for storing small animals such as mice. The caging system includes an exhaust system that may blow clean air into cages, and the exhaust system may also blow dirty air out of the cages such that the cages may be refreshed as necessary. The caging system also includes a temperature control system that may allow the temperature of the various cages to be heated in zones at preferred temperatures for storing small animals.

### CROSS-REFERENCE TO RELATED APPLICATIONS

This application claims the benefit of U.S. Provisional Application No. 61/983,023, filed Apr. 23, 2014, which is hereby incorporated by reference in its entirety.

### BACKGROUND OF INVENTION

The present invention relates to animal storage. In particular, it relates to securing small laboratory animals such as mice or rats kept in large numbers for use in medical and pharmaceutical studies by the National Institute of Health, medical schools, universities, and pharmaceutical companies.

Presently, vivariums are used to store animals for use in the aforementioned studies. A vivarium is an enclosure, container, or structure adapted or prepared for keeping animals under semi-natural conditions. Terrariums and aquariums are examples of types of vivariums. Typically, different types of animal holding rooms, floors, or buildings are referred to as vivariums.

Vivariums presently exist in the prior art and are frequently used for animal storage. For example, the Vivarium-IVCS (Individually-Ventilated Caging System) is a prior art vivarium that delivers ambient inlet air to each cage and further removes stale air from each cage. Thus, if the ambient room temperature is 72° F., the inlet air for the cages is also 72° F. Such a Vivarium-IVCS may include 160 individual cages, though there may be fewer or more cages included in the vivarium.

Prior art vivarium modules, which are often removable and supported by a rack, commonly include a plurality of vertical and horizontal plenums, as well as plastic cages that are received by the vertical plenum. Each vertical plenum includes an inlet for receiving clean ambient airflow and an outlet for removing dirty exhaust airflow. An inlet air blower and an exhaust air handler may be positioned and located on top of the vivarium that each are in fluid communication with the inlets and outlets of the vertical plenums. The vivarium may also include a controller for inlet and outlet air handlers and touch screen controls. The rack used to support the aforementioned components is mounted on a known facility surface or wheels so it may easily be moved about a laboratory space or cleaning facility.

The flow of air in the prior art vivarium-IVCS is typically as follows: inlet air is drawn into and filtered by the inlet air blower. The inlet air is forced into a horizontal plenum which is in fluid communication with the vertical plenums. Each vertical plenum is divided into an inlet air duct and a separate outlet air duct. The inlet duct in the vertical plenum distributes inlet air to each cage and the exhaust duct removes stale air from each cage. The stale air flows through the horizontal plenum back to the exhaust air handler. The exhaust air may be directed into the lab or elsewhere.

Over time, the plastic cages become soiled or need to be prepared for a new experiment and new rodents. Prior to cleaning, each module is removed from the support rack. The rack, the horizontal plenum and vertical plenums are then cleaned in a room-sized dishwasher-style cleaner. The plastic cages are usually also washed and autoclaved (sterilized by steam/heat). The controller and inlet/outlet air handlers may also be wiped down with disinfectant. All modules are then reassembled on the support rack.

The plastic cages used in the prior art have a top section which is removable from the bottom section to facilitate inserting and removing rodents from the plastic cage. The plastic cage includes two orifices which are sized and positioned for alignment with inlet and exhaust air respectively. Each orifice is covered by a spring-loaded flap door to keep mice or other animals isolated when an individual cage is removed from the vivarium. Each cage should further be able to be autoclaved for cleaning.

A horizontal plenum is in fluid communication with the inlet air blower, exhaust handler, and each of the vertical plenums. Each horizontal plenum is divided into inlet air ducts and exhaust air ducts such that inlet air is forced into each cage, and exhaust air is removed from each cage. Outlets in fluid communication with the inlet and exhaust ducts are positioned and located on the bottom portion of a horizontal plenum.

The vertical plenums of the prior art are typically formed from stainless steel in order to facilitate cleaning However, stainless steel is not an ideal material for heat-transfer/thermal-conductivity. The vivarium may include a plurality of vertical plenums. One embodiment of a prior art vivarium includes 8 vertical plenums for front cages and 8 vertical plenums for rear cages. A plurality of articulated support arms extend from each vertical plenum, and each cage is supported by a left and a right support arm.

For each pair of support arms (and therefore for each cage received by vertical plenum) a pair of nozzles typically protrudes from the vertical plenum and is axially aligned with the spring loaded flap doors and holes in the rear of each cage described above. When a cage is returned to be contained within the support arms, both nozzles fit through the holes in the rear of each cage and push open each flap door. In this fashion, the inlet nozzle provides fresh filtered air to each cage and the exhaust nozzle removes stale air from each cage, as described above.

The inlet air blower, which is positioned above and is in fluid communication with a horizontal plenum, draws ambient air from its environment (e.g., a laboratory space) through HEPA filters and directs the inlet air into the horizontal plenum and down the inlet air duct of each vertical plenum in the vivarium-IVCS. The outlet air handler draws exhaust air from each cage via the outlet duct of the vertical plenum such that it may be discharged to an exhaust system in order to help reduce foul odor in the laboratory or other work environment.

A microcontroller is mounted in the exhaust-fan enclosure housing. Power to the controller is supplied by a power cord plugged into the wall, in this embodiment 110VAC. Conductors connect the controller to the inlet air and outlet air blowers. The controller, by way of an LCD/touchscreen, may be set to control both the speed of the fans in the blowers and also notify (through alarming) when there are errors during normal use.

A separate prior art vivarium for use with growing animals for use in laboratories includes static cages without inlet and outlet ports. The cages of the vivarium are heated by mounting heating elements under the shelves, which in turn may heat the cages. In this arrangement, however, the temperature of the cages may not be set at an ideal temperature.

The thermal neutral zone, also known as a thermoneutral environment, is a temperature range for a given animal wherein the basal rate of heat production is in equilibrium with the rate of heat loss to the external environment. The animal does not have to use large amounts of energy to control its temperature within the thermal neutral zone. The animal adjusts to the temperature within the zone through different responses requiring little energy.

The Guide for the Care and Use of Laboratory Animals by the National Research Council of National Academy Press, Eight Version, 2011 recommends an ideal temperature range for mice of between 78.8° F. to 93.2° F. Thus, an investigator doing studies may need a new vivarium holding unit that will hold the cage temperature to 86° F.±1-2° F. Yet, because the technicians do not want to work in a lab with an 86° F. temperature, a solution is desired wherein the mice are provided with a thermoneutral microenvironment, and the room is at a comfortable temperature for the technicians. The solution may also be configured such that different cages of the vivarium may be maintained at different temperatures in order to satisfy a variety of ideal thermoneutral microenvironments.

### SUMMARY OF INVENTION

The present invention relates to small animal storage. More particularly, the present invention relates to a caging system that releasably secures a plurality of cages for housing small animals that may be removed from the cage when ready for experimentation.

The caging system may be mounted on wheels such that it is easily moveable around a laboratory floor, or it may alternatively be mounted to a facility surface in a manner well known and understood in the art. The caging system preferably includes a rack member that acts as a support means for the various components of the caging system, though other foundational structures for supporting the components of the caging system are further envisioned herein.

A plurality of vertical plenums may be associated with and releasably attached with the rack member. The plurality of vertical plenums may each include both an inlet supply channel and an output exhaust channel that run the length of the vertical plenum. An exhaust system associated with a horizontal plenum positioned and located at the top of the plurality of vertical plenums preferably blows clean air into the cages associated with the caging system by way of the inlet supply channel, and the exhaust system also preferably draws dirty air out of the cages by way of the output exhaust channel such that it may be filtered and blown out of the cage.

The caging system further includes a mechanism for controlling temperatures of the caging system such that cages associated with the caging system may be maintained at specific temperatures. A heating element such as a silicon encased wafer may be placed along the vertical plenums such that the cages may each be heated. In at least one embodiment, the heating elements may each include a thermistor such that the thermistor may transmit temperature information to a controller that may regulate the temperature in a “zone” of cages. Alternatively, each cage may have a heating element such that each cage may be maintained at a desired temperature. Allowing the cages to be temperature-controlled may prevent animals housed therein from becoming too warm or too cool, depending on the procedure that is going to be performed during subsequent lab testing.

### DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 is a perspective view of an individually vented caging system according to the teachings of the present invention.

FIG. 2 is a perspective view of a rack and watering system of the individually vented caging system of FIG. 1.

FIG. 3 is a front elevation view of a vertical plenum and horizontal plenum of the individually vented caging system of FIG. 1.

FIG. 4 is an exploded perspective view of a vertical plenum and a cage of the individually vented cage system of FIG. 1.

FIG. 5 is a partial enlarged view of the vertical plenum of FIG. 4.

FIG. 6 is an enlarged perspective view of the cage of FIG. 4.

FIG. 7 is a right side elevation view of the vertical plenum of FIG. 4.

FIG. 8 is an exploded perspective view of the horizontal plenum of FIG. 3.

FIG. 9 is a bottom perspective view of the horizontal plenum of FIG. 8.

FIG. 10 is an enlarged perspective view of the horizontal plenum of FIG. 9.

FIG. 11 is a rear perspective view of the vertical plenum of FIG. 4.

FIG. 12 is a rear perspective view of an alternative embodiment to the vertical plenum of FIG. 11.

FIG. 13 is a top plan view of the alternative embodiment illustrated in FIG. 12.

### DETAILED DESCRIPTION OF THE INVENTION

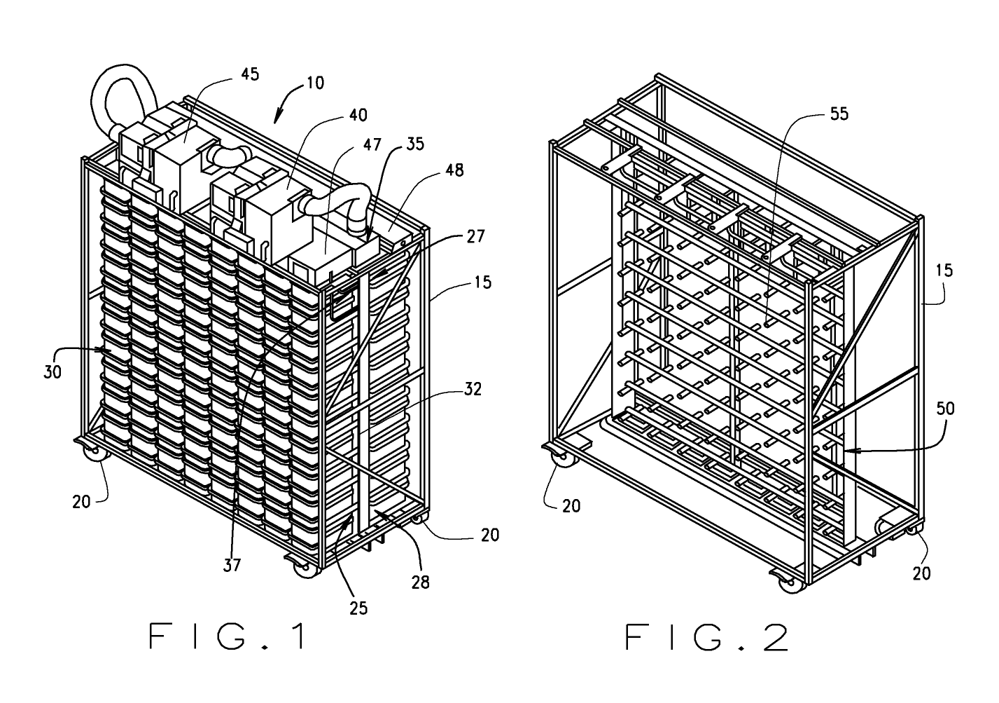

The present invention is directed generally toward securing small animals such as mice and rats for use in medical or pharmaceutical studies by researchers, corporations, or universities. FIG. 1 is an illustration of an individually vented caging system 10, hereinafter referred to as caging system 10. Caging system 10 may preferably be used for securing small animals, where they may be stored for long or short periods until they are removed for experimental purposes. Caging system 10 may include a rack member 15 that preferably serves as a support structure for the various components associated with caging system 10 in a manner further described below. Rack member 15 preferably includes wheels 20 for more easily transporting caging system 10 throughout a storage facility. The illustrated caging system 10 includes four wheels 20. Alternatively, rack member 15 may be mounted to a facility surface in a manner foreseeable to those having ordinary skill in the art.

Rack 15 may include a top portion 27 and a bottom portion 28. A plurality of vertical plenums 25, as best illustrated in FIG. 4, may releasably attach to the top portion 27 and bottom portion 28 of rack 15. Vertical plenums 25 may include a plurality of arms for receiving and releasably securing a plurality of cages 30 when cages 30 are associated with caging system 10 such that they may be used to secure animals therein. The vertical plenums 25 may abut one another, and are adjacent to one another such that cages 30 may be received by adjacent vertical plenums 25 such that they may be in a side by side configuration. Vertical plenums 25 also may be placed such that back portions 32 thereof may abut one another, and cages 30 may be placed on either side of caging system 10 such that the number of cages being stored by caging system 10 may be increased. Vertical plenums 25 may be made of stainless steel, or of another suitable material in order to generate greater heat-transfer/thermal-conductivity. The functional aspects of vertical plenums 25 are described in greater detail herein below.

As seen in FIG. 1, a horizontal plenum 35 may be further attached to a top portion 37 of the plurality of vertical plenums 25. A horizontal plenum 35 may be in fluid communication with an inlet air blower 40 and exhaust handler 45, and each of the plurality of vertical plenums 25 as discussed below. Caging system 10 may not only provide storage for a plurality of cages 30, but it also may provide a system for blowing clean air into cages 30 and drawing dirty air from a cage 30 via blower 40 and handler 45, respectively. A heater control unit 47 and a power distribution channel 48 are further illustrated in FIG. 1. The functions of heater control unit 47 and power distribution channel 48 are described below when explaining the temperature control system of caging system 10.

FIG. 2 illustrates rack member 15 with the vertical plenums 25, cages 30, horizontal plenum 35, blower 40, and handler 45 removed. Rack member 15 may support plenums 25, 35, blower 40, and handler 45, as shown in FIG. 1, and preferably includes wheels 20, although it may alternatively be mounted to a facility surface. Rack member 15 may further include a watering system 50. Watering system 50 preferably provides water to animals in cages 30, and it is preferably a removable accessory. Watering system 50 may include a plurality of nozzles 55, each nozzle 55 able to be inserted into a cage 30 such that an animal may water therein.

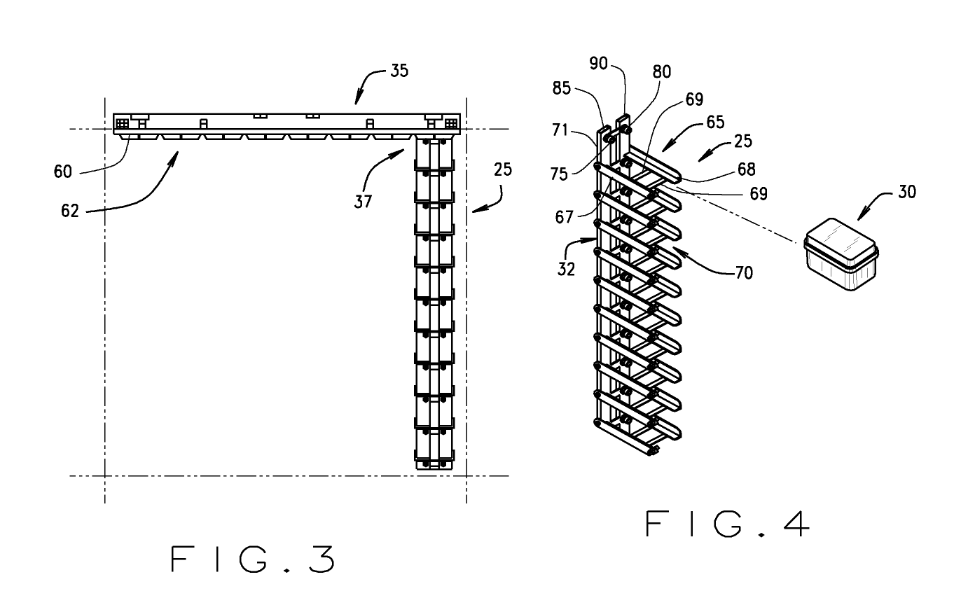

FIG. 3 provides a front elevation view of a vertical plenum 25 that has been received by and selectively engaged with a horizontal plenum 35 for fluid communication there between. FIG. 3 illustrates only one vertical plenum 25 being received by horizontal plenum 35 such that the horizontal plenum 35 receiving vertical plenum 25 is more clearly illustrated. In the preferred embodiment illustrated in FIG. 1, eight vertical plenums 25 are received by horizontal plenum 35 on each side of rack member 15, such that rack member 15 includes a total of sixteen vertical plenums 25. FIG. 3 also illustrates receiving mechanisms 60 which may be positioned and located on an underside portion 62 of horizontal plenum 35 and are described in greater detail herein below. In the embodiment illustrated in FIG. 3, the horizontal plenum 35 includes eight receiving mechanisms 60, each for receiving a vertical plenum 25 (not illustrated) on each side of rack 15 (a total of 16 receiving mechanisms 60, 8 in front and 8 in back).

FIG. 4 is an exploded perspective view of a vertical plenum 25 receiving a single cage 30. Each vertical plenum 25 may include a plurality of pairs of arms 65. Pairs of arms 65 may be vertically spaced apart from one another at a distance that is only slightly greater than the height of each cage 30. Each pair of arms 65 may include a left arm 67 and right arm 68. Arms 67 and 68 that make up a pair of arms 65 may be horizontally spaced apart such that the pairs of arms 65 may support the width of a cage 30. A support bar 69 associated with each pair of arms 65 may further help to secure each cage 30. In the illustrated embodiment, each pair of arms 65 is associated with two support bars 69, though more or fewer support bars 69 may be used.

A cage 30, when received by arms 67, 68 preferably fits snugly within a pair of arms 65 within a receptacle area 70, receptacle area 70 having top and bottom boundaries formed by vertically adjacent pairs of arms 65 and a back boundary formed by a rear wall 71 of vertical plenum 25. Cage 30 may be inserted into and removed from receptacle area 70 as needed to conduct experiments, maintain the cages, etc.

As is best seen in FIG. 5, when a receptacle area 70 receives a cage 30, two ports located at the rear of the cage 30 (not illustrated) may be located and positioned to align with an inlet nozzle 75 and outlet nozzle 80 extending from vertical plenum 25 toward a cage 30 that has been received by receptacle area 70. The ports may include spring-loaded flap doors for preventing in-cage air from escaping through the ports when a cage 30 has been removed from a receptacle 70.

When the ports of a cage 30 receive nozzles 75, 80, clean air may be blown into an individual cage 30 via inlet nozzle 75, and dirty air may be received and blown out from an individual cage 30 via outlet nozzle 80 to be expelled therefrom. Each receptacle 70 preferably includes an inlet nozzle 75 and outlet nozzle 80.

Each inlet nozzle 75 may be in fluid communication with an inlet supply channel 85 that extending vertically from top portion 27 of vertical plenum 25 through to a bottom portion of vertical plenum 25 (not illustrated). Inlet supply channel 85 may be closed at the bottom portion of vertical plenum 25 such that air is preferably only circulated in the channels 85, 90, cages 30, blower 40, and handler 45 such that stale air that may be foul-smelling is not released into the laboratory environment. As inlet supply channel 85 extends downwardly toward the bottom portion of plenum 25, it may be in fluid communication with each inlet nozzle 75 of receptacles 70. Thus each inlet nozzle 75 of a vertical plenum 25 is preferably in fluid communication with inlet supply channel 85.

Similarly, each outlet nozzle 80 may be in fluid communication with an outlet supply channel 90 that preferably extends vertically from top portion 27 of vertical plenum 25 to the bottom portion of vertical plenum 25. Outlet supply channel 90 may be closed at the bottom portion of each vertical plenum 25. As outlet supply channel 90 moves downwardly toward the bottom portion of plenum 25, channel 90 may be in fluid communication with each outlet nozzle 80 of receptacles 70. Thus each outlet nozzle 80 of a vertical plenum 25 may be in fluid communication with outlet supply channel 90. Because ports of a cage 30 are in fluid communication with an inlet nozzle 75 and outlet nozzle 80, a cage 30 may be in fluid communication with channels 85, 90.

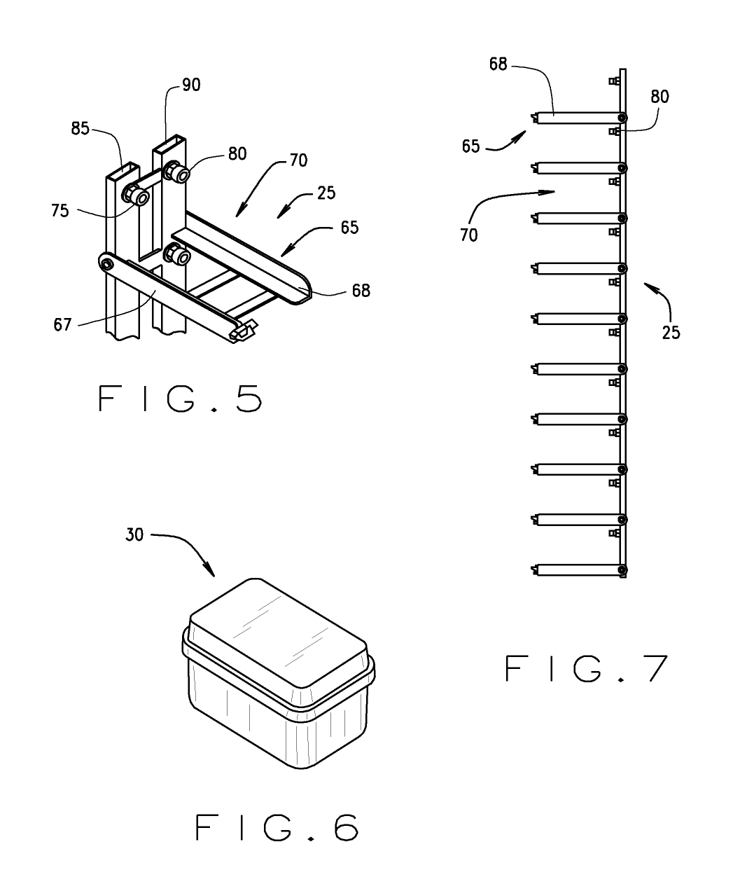

FIG. 6 illustrates cage 30 in enlarged form. FIG. 7 illustrates a front right side elevation view of a vertical plenum 25. In FIG. 7, right arms 68 of arm pairs 65 are visible, and receptacles 70 and outlet nozzles 80 are illustrated in greater detail. Inlet nozzles 75 and left arms 67 (not illustrated in FIG. 7) may be positioned and located so as to be in substantial alignment with outlet nozzles 80 and right arms 68, respectively.

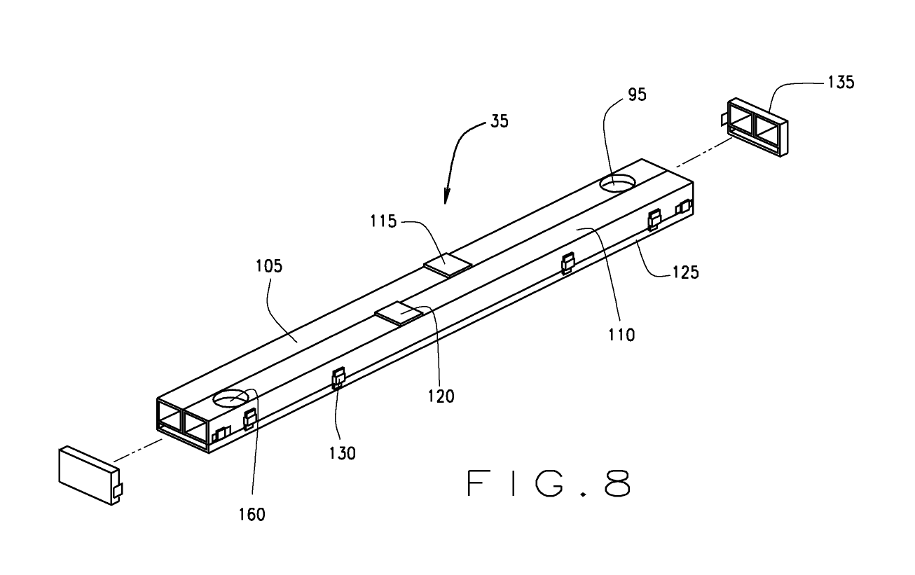

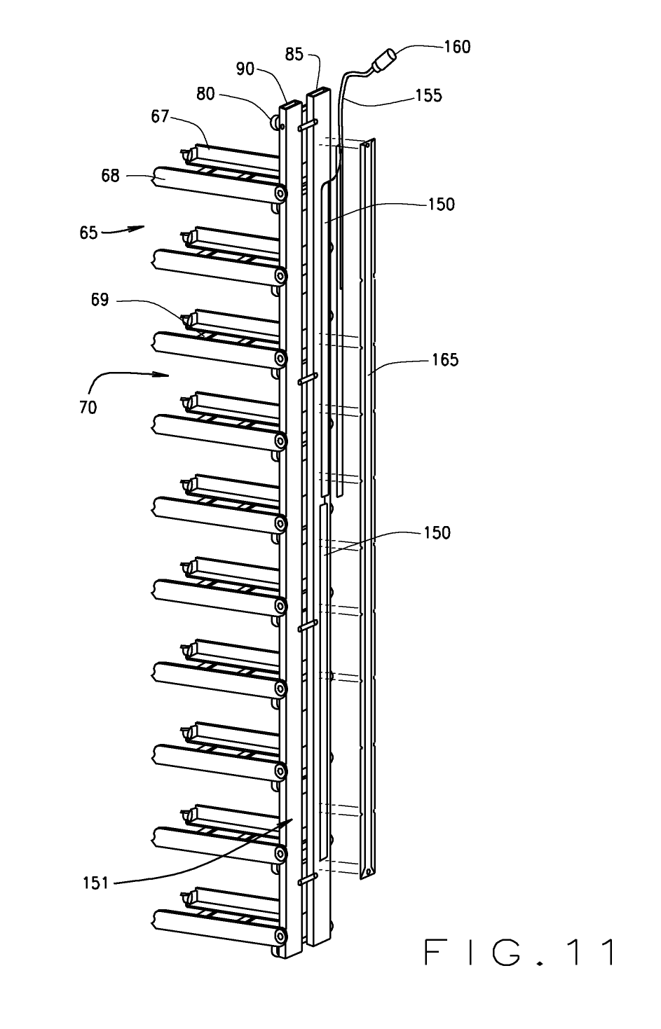

FIGS. 8-10 illustrate an embodiment of a horizontal plenum 35. Horizontal plenum 35 may be in fluid communication with blower 40 and handler 45 via blower inlet 95 and handler outlet 100, respectively. Blower 40 and blower inlet 95 may be in fluid communication with one another via tubing or other means known throughout the art. Handler 45 and handler outlet 100 may be in fluid communication by substantially similar means as those associated with blower 40 and blower inlet 95.

Horizontal plenum 35 may include a supply duct cover 105 and an exhaust duct cover 110 for containing supply air and exhaust air therein, respectively. Supply duct cover 105 may include a supply duct sensor port 115 for measuring air therein, and exhaust duct cover 110 may include an exhaust duct sensor port 120 for measuring air therein. A bottom cap member 125 preferably extends across the length of horizontal plenum 35 and across the width of horizontal plenum 35 when duct covers 105 and 110 are adjacent to one another. Latches 130 may releasably attach the duct covers 105, 110 and bottom cap member 125. Other means for releasably attaching duct covers 105, 110 and bottom cap member 125 are further contemplated herein. End caps 135 may be releasably attached to each of the longitudinal end portions of horizontal plenum 35 to help prevent supply and exhaust air from escaping therefrom and potentially cause undesirable smells in a laboratory space.

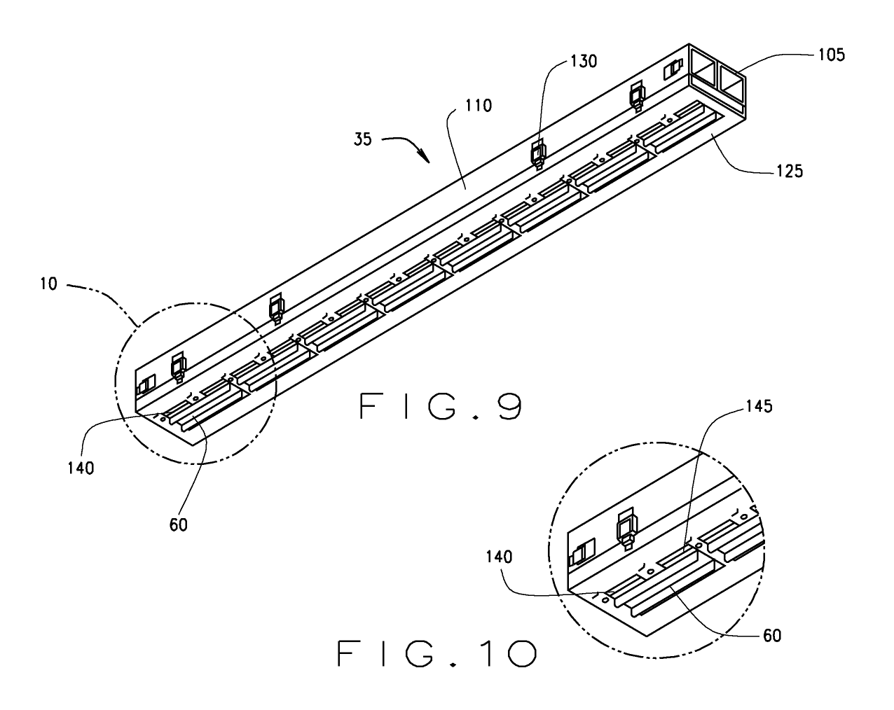

FIG. 9 illustrates duct covers 105 and 110, and a plurality of receiving mechanisms 60 may be seen on the bottom portion of bottom cap member 125. Horizontal plenum 35 is preferably positioned and located such that the receiving mechanism 60 of the horizontal plenum 35 receives and releasably attaches vertical plenums 25 with the horizontal plenum 35 at various intervals along the length of horizontal plenum 35. Each receiving mechanism 60 may include a supply receiver 140 and an exhaust receiver 145. Supply receiver 140 is preferably positioned and located to receive and releasably attach supply channel 85, and exhaust receiver 145 is preferably positioned and located to receive and releasably attach exhaust channel 90 thereto when a vertical plenum 25 and horizontal plenum 35 are attached with one another, as illustrated in FIG. 3. When receivers 140, 145 receive channels 85, 90, respectively, channel 85 may be in fluid communication with supply duct cover 105, and channel 90 may be in fluid communication with exhaust duct cover 110.

When a vertical plenum 25 is attached with a horizontal plenum 35, and a cage 30 is received by a receptacle 70, blower 40 may generate blower air in a manner known in the art, enter the supply duct cover 105 via blower inlet 95, enter supply channel 85, be passed through an inlet nozzle 75, and be passed into cage 30 via a supply port (not illustrated). Meanwhile, dirty exhaust air may be discharged via an outlet nozzle 80 to exhaust channel 90, into the exhaust duct cover 110 via handler outlet 100, and into handler 45 for processing.

In addition to the described ventilation system, caging system 10 further may provide a system and method for maintaining the temperature of individual cages 30 or groups of cages 30. In one embodiment, flexible silicone encased heating elements 150 may be releasably attached to rear back portion 151 of vertical plenums 25 as illustrated in FIG. 11. In at least one alternative embodiment, stiff stainless steel housed element rods may be attached to back portions 151 of vertical plenums 25. Alternatively, one or more heating elements 150 may be positioned within each vertical plenum 25, preferably within supply channel 85. Each element 150 that is associated with a vertical plenum 25 may include one thermistor (not illustrated) for providing temperature feedback to a controller 47 from the heat generated by element 150. As shown in FIG. 11, two separate heating elements 150 are shown in connection with a vertical plenum 25. It is understood that each cage 30 could have its own individual heating element 150 in at least one embodiment. A cord 155 may extend through an element 150 in the illustrated embodiment, and a multi-connector 160 may extend therefrom for attachment with a power source. In the illustrated embodiment, the power source may be housed within power distribution channel 48. Alternatively connector 160 may be mated with a standard wall plug in a manner known throughout the art. An element mounting flange 165 may further be mounted to rear portions 151 of each vertical plenum 25, so as to protect element 150 housed therein from the wear and tear associated with caging systems 10. In alternative embodiments, elements 150 may be manufactured not from silicon, but from other heating elements such as the Firerod heating element made by Watlow. Other heating elements known throughout the art are also considered foreseeable alternatives.

Electronics associated with heater control unit 47 may control the various temperatures associated with heating elements 150. Control unit 47 may include a touch screen able to control various aspects of the caging system 10 including blower 40, handler 50, and heating elements 150, either alone or in combination. When the control unit includes only one of the aforementioned components, other controllers may be necessary to control the remaining components. Because each vertical plenum 25 may include any number of heating elements 150 associated therewith, vertical plenums 25 may be thermo-controlled to a fine degree. More specifically, when multiple heating elements 150 are associated with one vertical plenum 25, different sections of that vertical plenum 25 may be maintained at different temperatures, or the multiple heating elements 150 may be operated at various heating levels in order to obtain a uniform temperature throughout the vertical plenum 25 despite different ambient conditions. This structure may heat the inlet air close to cages 30, allowing for more control and uniformity throughout, and less variation in inlet air temperature which may be caused by varying travel distances and times for the inlet air as it travels to cages 30 at different positions of caging system 10. This can be particularly useful if the animals secured within cages 30 require thermoneutral environments for laboratory studies.

Moreover, heating elements 150 may be programmable via their thermistors and control unit 47 for being coordinated in “zones” (not illustrated). These zones may be regions of cages 30 within caging system 10 that each may be set at a specific control temperature, or each of which require similar heat amounts from their associated heating elements 150.

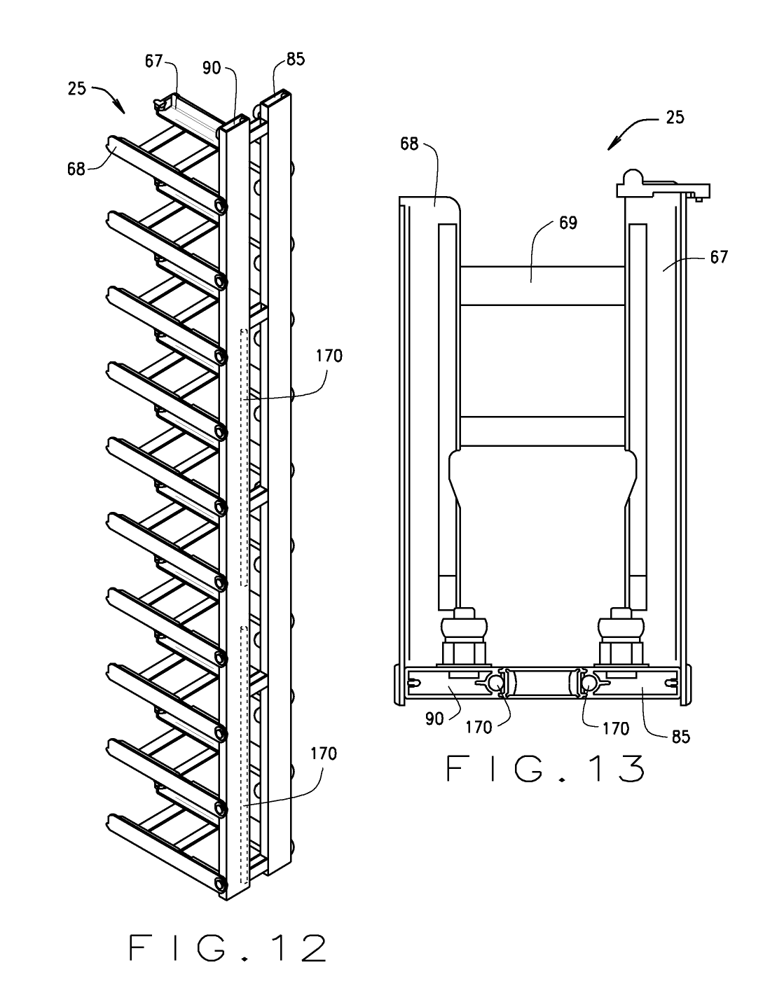

FIGS. 12 and 13 illustrate alternative embodiments of the present invention wherein heating rods 170 are utilized rather than heating elements 150 to provide heat to caging system 10 and cages 30 (not shown in FIGS. 12 and 13) thereof. Heating rods 170 may preferably be positioned within channel 85 and/or channel 90 of each vertical plenum 25. In FIG. 12, a heating rod 170 is shown only within channel 90, but in FIG. 13, a heating rod 170 is shown in each of channels 85, 90. The manner in which heating rods 170 may be attached within the channels 85, 90 are known in the art.

The position and location of heating rods 170 may be customizable and adaptable such that heat may be provided to cages 30 in various “zones” as preferred by a user. A user may choose to move heating rods 170 to various locations, thus adjusting the temperature of various cages 30, so as to provide a temperature for maintaining mice or other animals within cages 30 at a desired temperature. In the preferred embodiment, heating rods 170 may be made of stainless steel, but other thermo-conductive materials are contemplated herein.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention.

What is claimed is:

1. A caging system for storing small animals, said caging system comprising:
a rack member for supporting said caging system;
a plurality of cages for housing said small animals, said plurality of cages releasably engageable with said rack member;
a plurality of vertical plenums, each of said vertical plenums being releasably attachable to said rack member, each of said plurality of vertical plenums comprising at least one supply channel and at least one exhaust channel, said at least one supply channel and said at least one exhaust channel for refreshing air within said plurality of cages;
at least one horizontal plenum releasably attachable to said plurality of vertical plenums; and
a plurality of heating elements, each of said heating elements releasably attached with each of said plurality of vertical plenums.

2. The caging system of claim 1, wherein the plurality of cages each include an inlet nozzle and an outlet nozzle.

3. The caging system of claim 2, wherein the inlet nozzle is in fluid communication with the supply channel, and the outlet nozzle is in fluid communication with the exhaust channel.

4. The caging system of claim 1, wherein the caging system includes an air inlet blower in fluid communication with the horizontal plenum.

5. The caging system of claim 1, wherein the caging system includes an exhaust handler in fluid communication with the horizontal plenum.

6. The caging system of claim 1, wherein the rack member includes a watering system in fluid communication with the plurality of cages.

7. The caging system of claim 1, wherein each of the plurality of heating elements are associated with each of the cages of the caging system.

8. The caging system of claim 1, wherein the plurality of heating elements are positioned and located within the supply channel of the vertical plenum.

9. The caging system of claim 1, wherein the plurality of heating elements are encased by flexible silicon.

10. The caging system of claim 1, wherein the plurality of heating elements each include at least one thermistor.

11. A caging system for storing small animals, said caging system comprising:
a plurality of cages for housing said small animals, said plurality of cages releasably engageable within said caging system;
a plurality of vertical plenums, each of said vertical plenums being releasably attachable to said caging system,
at least one horizontal plenum releasably attachable to said plurality of vertical plenums; and
a plurality of heating elements, each of said heating elements releasably attached with each of said plurality of vertical plenums.

12. The caging system of claim 11, wherein each of the plurality of vertical plenums includes at least one supply channel and at least one exhaust channel.

13. The caging system of claim 12, wherein the plurality of cages each include an inlet nozzle and an outlet nozzle.

14. The caging system of claim 13, wherein the inlet nozzle is in fluid communication with the supply channel, and the outlet nozzle is in fluid communication with the exhaust channel.

15. The caging system of claim 11, wherein the caging system includes an air inlet blower in fluid communication with the horizontal plenum.

16. The caging system of claim 11, wherein the caging system includes an exhaust handler in fluid communication with the horizontal plenum.

17. The caging system of claim 11, wherein the caging system includes a rack member for supporting the horizontal plenum and the plurality of vertical plenums. includes a watering system in fluid communication with the plurality of cages.

18. The caging system of claim 11, wherein each of the plurality of heating elements are associated with each of the cages of the caging system.

19. The caging system of claim 11, wherein the plurality of heating elements are positioned and located within the supply channel of the vertical plenum.

20. The caging system of claim 11, wherein the plurality of heating elements each include at least one thermistor.
